(19) United States
(12) Patent Application Publication
(10) Pub. No.: US 2005/0259671 A1
(43) Pub. Date: Nov. 24, 2005

(54) Information processing apparatus and method for wireless network

(75) Inventors: Hye-young Jung, Seoul (KR); Byung-in Mun, Suwon-si (KR); Hyeong-seok Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/131,364

(22) Filed: May 18, 2005

(30) Foreign Application Priority Data
May 18, 2004 (KR) 10-2004-0035262

(51) Int. Cl. H04L 12/28; H04L 12/56; H04B 7/00

(52) U.S. Cl. 370/410; 370/310

(57) ABSTRACT

An information processing apparatus and method for a wireless network are provided. The information processing apparatus and method ensure a wide bandwidth by reducing traffic in the wireless network. The information processing apparatus includes a first information storage unit storing router information regarding a wireless network, and an information transmitter transmitting the router information to the mobile terminal contained in the list.

### CROSS-REFERENCE TO RELATED APPLICATIONS

This application claims priority from Korean Patent Application No. 10-2004-0035262 filed on May 18, 2004 in the Korean Intellectual Property Office, the disclosure of which is incorporated herein by reference in its entirety.

### BACKGROUND OF THE INVENTION

1. Field of the Invention

The present invention relates to an information processing apparatus and method for a wireless network, and more particularly, to an information processing apparatus and method ensuring a wide bandwidth by reducing traffic in a wireless network.

2. Description of the Related Art

As mobile communication equipment rapidly spreads, Internet service is required even in a wireless environment as users desire to use the Internet to guarantee mobility.

To provide such Internet service, studies on a wireless local area network (LAN), a mobile Internet Protocol (IP), Mobile Ad Hoc Network (MANET), etc., have been performed actively.

Among those, MANETs in association with an Internet Protocol version 6 (IPv6) have been highlighted as a solution supporting a home network connecting all household terminals via a wired and/or wireless connection and supporting wired and wireless data communication by allocating an IP to every mobile terminal.

The IPv6 is an upgraded version of IPv4. The IPv6 is compatible with the IPv4 and is designed to efficiently operate in a low speed network such as a wireless network as well as a high speed network such as an asynchronous transfer mode (ATM) network.

In using IPv4 on the Internet, there may be a lack of addresses that can be allocated to new terminals as the number of connected terminals increases. Accordingly, it is a primary consideration in the development of IPv6 to increase the number of devices that can be connected to the Internet.

To increase the number of devices connected to the Internet, an address size in the IPv6 is 128 bits greater than the address size of 32 bits in the IPv4.

FIG. 1 illustrates the structure of a typical wireless network. Each of access routers 11 and 21 of respective wireless networks 10 and 20 sends to a plurality of mobile terminals MN a router information message needed for automatic address configuration.

The router information message contains information such as an address and lifetime of an access router. Through the router information message, each mobile terminal MN can identify a wireless network to which it belongs and configure an address automatically.

When this typical wireless network is associated with the IPv6, as shown in FIG. 2, a plurality of access routers 30 and 40 broadcast their router information messages to a plurality of mobile terminals MN1.

Through such broadcast, router information is transmitted throughout the wireless network.

Here, the mobile terminals MN1 receive all of the router information messages sent by the access routers 30 and 40.

In addition, since a network is formed via a plurality of hops in the wireless network associated with the IPv6, traffic in the wireless network continuously changes when mobile terminals MN1 move.

The access routers 30 and 40 periodically broadcast their router information messages because of the movement of the mobile terminals MN1.

Accordingly, the overall traffic in the wireless network increases due to the periodic transmission of the router information messages by the access routers 30 and 40, and therefore, a bandwidth used for normal communication of the mobile terminals MN1 is reduced. As a result, delay of the normal communication and packet loss may occur.

### SUMMARY OF THE INVENTION

The present invention provides an information processing apparatus and method for a wireless network, by which transmission of router information, which is needed to allow a mobile terminal to identify a wireless network where the mobile terminal belongs and configure an address is minimized, thereby reducing traffic in the wireless network.

The above stated aspect as well as other aspects, features and advantages, of the present invention will become clear to those skilled in the art upon review of the following description.

According to an aspect of the present invention, there is provided an information processing apparatus for a wireless network, including a list storage unit storing a list containing information of a mobile terminal sending a router information request message regarding the wireless network, a first information storage unit storing router information regarding the wireless network, and an information transmitter transmitting the router information to the mobile terminal contained in the list.

According to another aspect of the present invention, there is provided an information processing apparatus for a wireless network, including an information requester sending a router information request message to a mobile terminal of the wireless network, an information receiver receiving router information corresponding to the router information request message, and a second information storage unit storing the received router information.

According to still another aspect of the present invention, there is provided an information processing method for a wireless network, including storing a list containing information of a mobile terminal sending a router information request message regarding the wireless network, storing router information regarding the wireless network, and transmitting the stored router information to the motile terminal contained in the list.

According to yet another aspect of the present invention, there is provided an information processing method for a wireless network, including sending a router information request message to a mobile terminal of the wireless network, receiving router information corresponding to the router information request message, and storing the received router information.

### BRIEF DESCRIPTION OF THE DRAWINGS

The above and other features and advantages of the present invention will become more apparent by describing in detail preferred embodiments thereof with reference to the attached drawings in which:

FIG. 1 illustrates the structure of a typical wireless network;

FIG. 2 illustrates the structure of a conventional Mobile Ad Hoc Network (MANET) using an Internet Protocol version 6 (IPv6);

FIG. 3 illustrates an information processing apparatus for a wireless network according to an exemplary embodiment of the present invention;

FIG. 4 illustrates the structure of a list containing mobile terminal information according to an exemplary embodiment of the present invention;

FIG. 5 illustrates a method by which an access router sends a router information message, according to an exemplary embodiment of the present invention;

FIG. 6 illustrates a method by which a mobile terminal sends a router information request message, according to an exemplary embodiment of the present invention;

FIG. 7 illustrates a method by which a mobile terminal receiving the router information request message shown in FIG. 6 transmits the router information request message;

FIG. 8 illustrates a method by which a mobile terminal transmitting the router information request message shown in FIG. 7 receives a router information message;

FIG. 9 illustrates a method of transmitting the router information message shown in FIG. 8 to a mobile terminal initially sending the router information request message;

FIG. 10 illustrates an access router including a protocol converter according to an exemplary embodiment of the present invention;

FIG. 11 is a flowchart of a method of transmitting router information to a mobile terminal requesting a router information message according to an exemplary embodiment of the present invention;

FIG. 12 is a flowchart of a method enabling a mobile terminal requesting a router information message to receive router information according to an exemplary embodiment of the present invention;

FIG. 13 illustrates the frequency of message transmission in a wireless network using an exemplary embodiment of the present invention; and

FIG. 14 illustrates a method by which the protocol converter converts a protocol, according to an embodiment of the present invention.

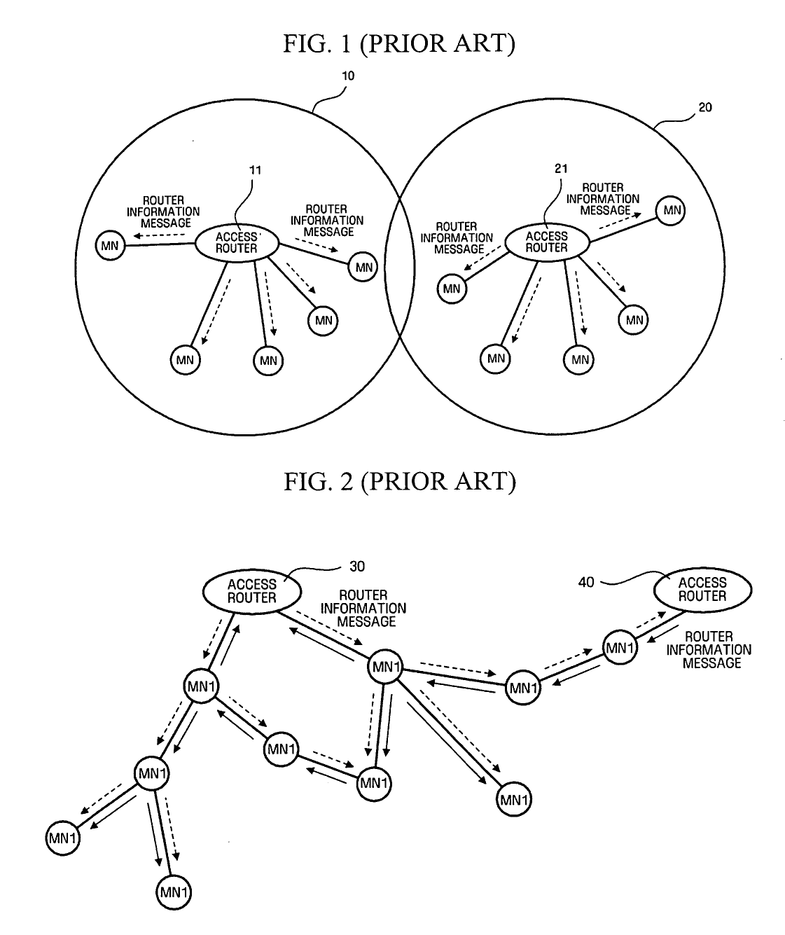

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

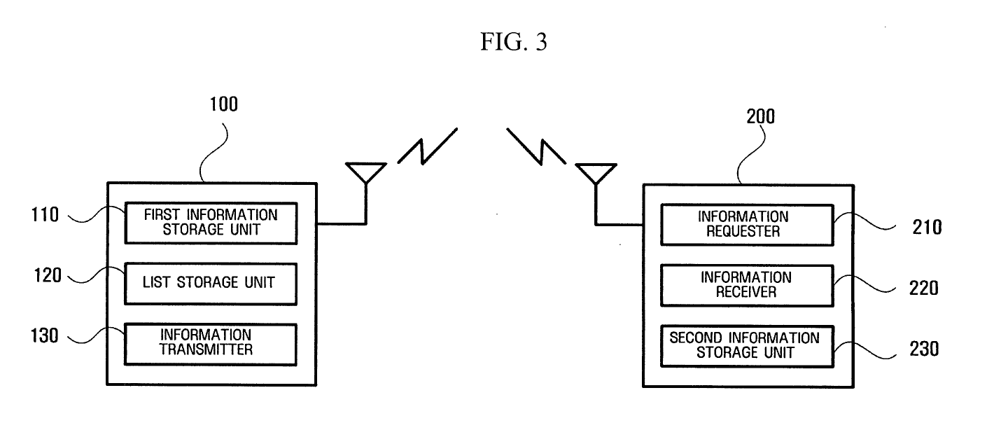

Referring to FIG. 3, an information processing apparatus for a wireless network according to an embodiment of the present invention may include a first mobile terminal 100 storing router information regarding a predetermined wireless network and a second mobile terminal 200 receiving the router information regarding the predetermined wireless network from the first mobile terminal 100.

In an embodiment of the present invention, it is assumed that the first mobile terminal 100 has been present in the wireless network and the second mobile terminal 200 newly enters the wireless network.

The first mobile terminal 100 may include a first information storage unit 110 storing router information regarding the wireless network, a list storage unit 120 storing a list containing information of a mobile terminal requesting the router information, and an information transmitter 130 sending the router information to the mobile terminal contained in the list.

The list stored in the list storage unit 120 contains information of each mobile terminal sending a router information request message to the first mobile terminal 100.

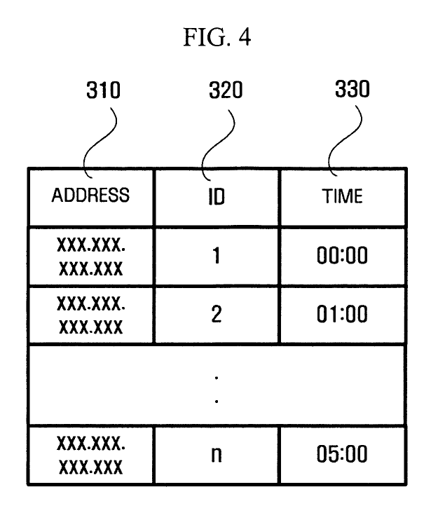

Referring to FIG. 4, the list may contain an address 310 of a mobile terminal sending a router information request message, a unique ID 320 of the router information request message, and time 330 when the router information request message is received.

It is preferable, but not necessary, that a mobile terminal sending a router information request message to the first mobile terminal 100 is within 1-hop distance. The number of hops may vary with network policy.

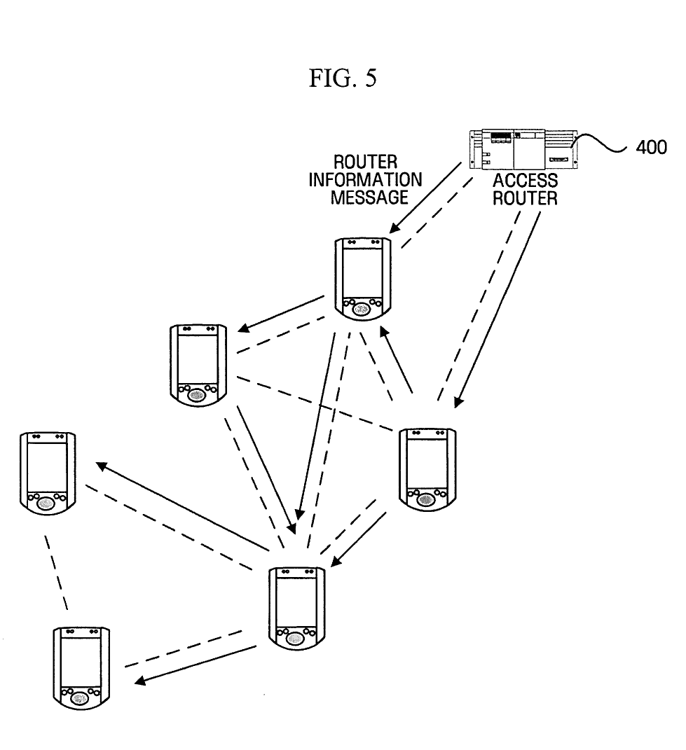

Referring to FIG. 5, when the wireless network is activated, that is, when an access router in the wireless network is turned on or router information is updated, the first mobile terminal 100 can receive and store a router information message transmitted from an access router 400.

The access router 400 may send a router information message without any request or in response to a router information request message sent by a mobile terminal needing the router information.

In FIG. 5, a broken line represents a wireless link and a solid line represents the router information message sent by the access router 400.

The access router 400 sends the router information message when the wireless network is activated and then does not send the router information message again until the router information is updated, and therefore, traffic in the wireless network can be reduced.

In addition, the access router 400 can broadcast router information to a maximum hop distance predetermined according to network policy and every mobile terminal within the maximum hop distance can receive and store the router information.

Meanwhile, the second mobile terminal 200 shown in FIG. 3 may include an information requester 210 sending a router information request message to the first mobile terminal 100 existing in the wireless network when the second mobile terminal 200 enters the wireless network, an information receiver 220 receiving router information corresponding to the router information request message, and a second information storage unit 230 storing the received router information.

It is preferable, but not necessary, that the second mobile terminal 200 sends the router information request message to a mobile terminal within 1-hop distance therefrom. The number of hops between the second mobile terminal 200 and a mobile terminal receiving the router information request message sent by the second mobile terminal 200 may be changed according to network policy.

In embodiments of the present invention, the first mobile terminal 100 is within 1-hop distance from the second mobile terminal 200.

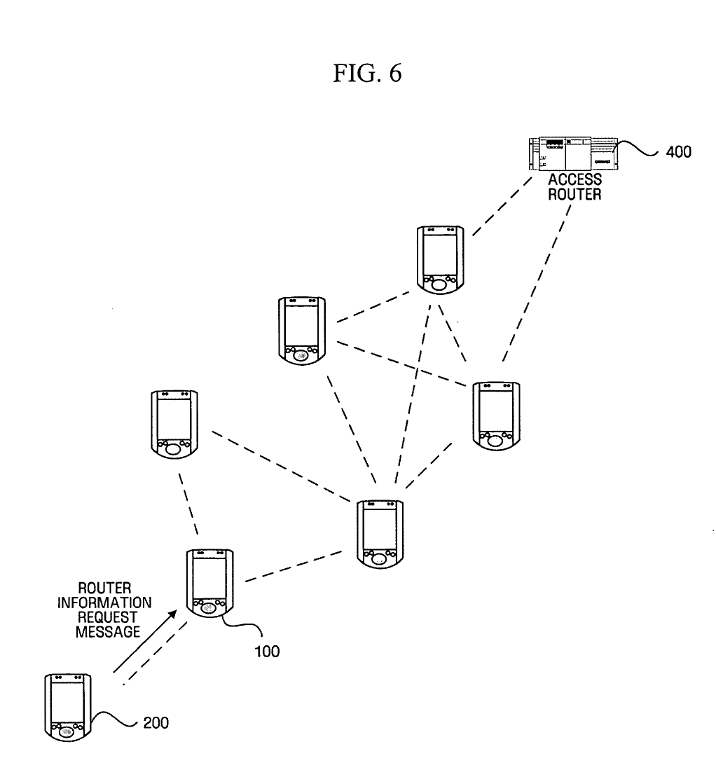

Referring to FIG. 6, since mobile terminals present in a wireless network receive a router information message from the access router 400 of the wireless network and store router information regarding the wireless network when the wireless network is activated, the second mobile terminal 200 may send a router information request message to the first mobile terminal 100 within 1-hop distance instead of sending the router information request message to the access router 400.

Upon receiving the router information request message, the first mobile terminal 100 stores information of the second mobile terminal 200 in the list storage unit 120 and determines whether it has router information corresponding to the router information request message.

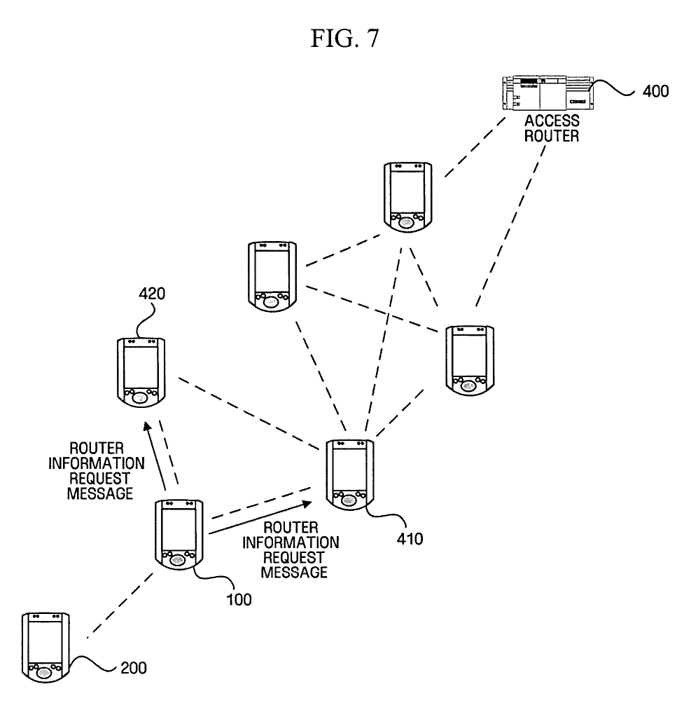

When the first mobile terminal 100 has the corresponding router information, the first mobile terminal 100 sends a router information message containing the router information to the second mobile terminal 200. When the first mobile terminal 100 does not have the router information, as shown in FIG. 7, it sends the router information request message to mobile terminals 410 and 420 within 1-hop distance therefrom like the second mobile terminal 200.

To this end, the individual elements 110, 120, and 130 of the first mobile terminal 100 and the individual elements 210, 220, and 230 of the second mobile terminal 200 may be separately or integrally included in the first mobile terminal 100 and the second mobile terminal 200.

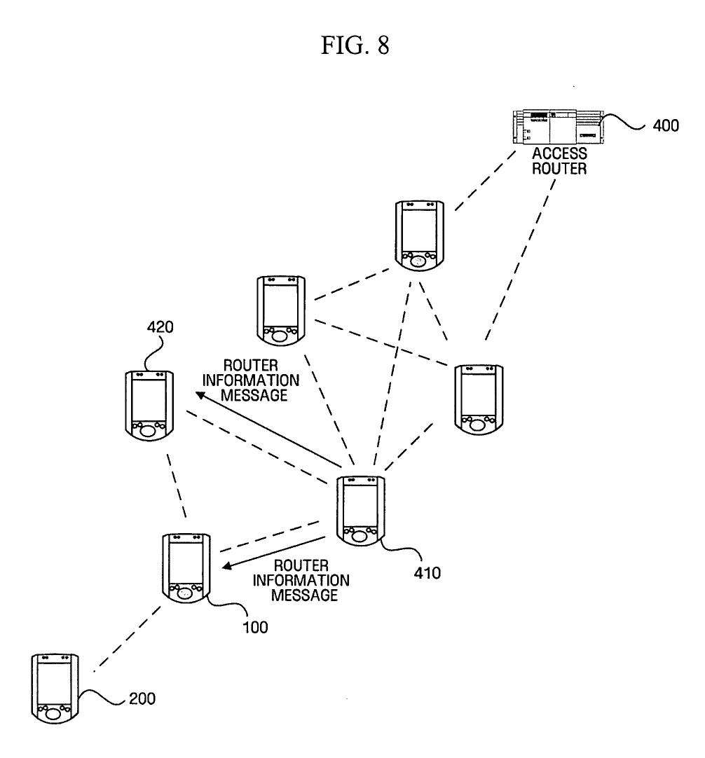

When the first mobile terminal 100 sends the router information request message, there may be a plurality of the mobile terminals 410 and 420 within the 1-hop distance from the first mobile terminal 100. In this case, to prevent the first mobile terminal 100 from receiving the router information redundantly, as shown in FIG. 8, the mobile terminal 420 within the 1-hop distance from the first mobile terminal 100 may not send the router information to the first mobile terminal 100 if the mobile terminal 410 sent the router information earlier.

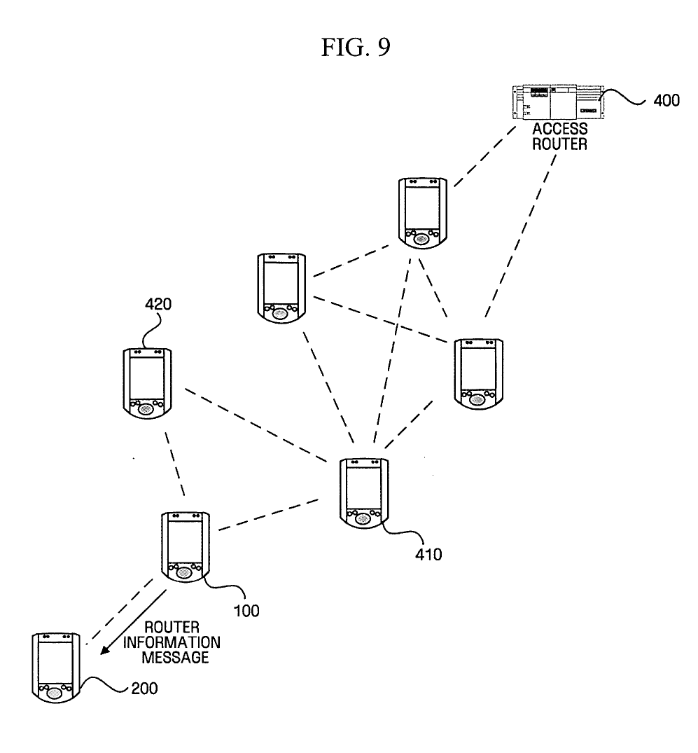

FIG. 9 illustrates a procedure in which the second mobile terminal 200 newly entering a wireless network receives a router information message regarding the wireless network from the first mobile terminal 100.

Meanwhile, the access router 400 may include a protocol converter converting a protocol when the first mobile terminal 100 and the second mobile terminal 200 transmit and receive messages using different protocols via the access router 400.

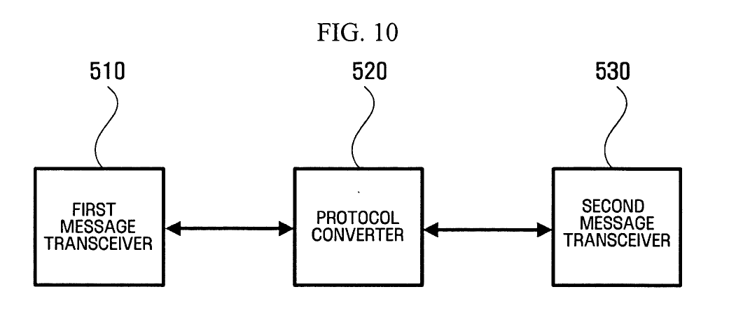

Referring to FIG. 10, the access router 400 may include a first message transceiver 510 transmitting and receiving messages using a protocol of a current wireless network, a second message transceiver 530 transmitting and receiving messages using a protocol different from the protocol of the current wireless network, and a protocol converter 520 disposed between the first message transceiver 510 and the second message transceiver 530 to convert the protocol of a message to be suitable to a wireless network to which the message is transmitted.

Here, the protocol converter 520 may be included in or separated from in the access router 400.

In addition, the first message transceiver 510, the protocol converter 520, and the second message transceiver 530 may be selectively integrated.

The following description concerns an information processing method performed by an information processing apparatus for a wireless network according to an embodiment of the present invention. The information processing method may be divided into a method by which the first mobile terminal 100 sends router information to a mobile terminal having sent a router information request message and a method by which the second mobile terminal 200 newly entering a wireless network receives router information regarding the wireless network.

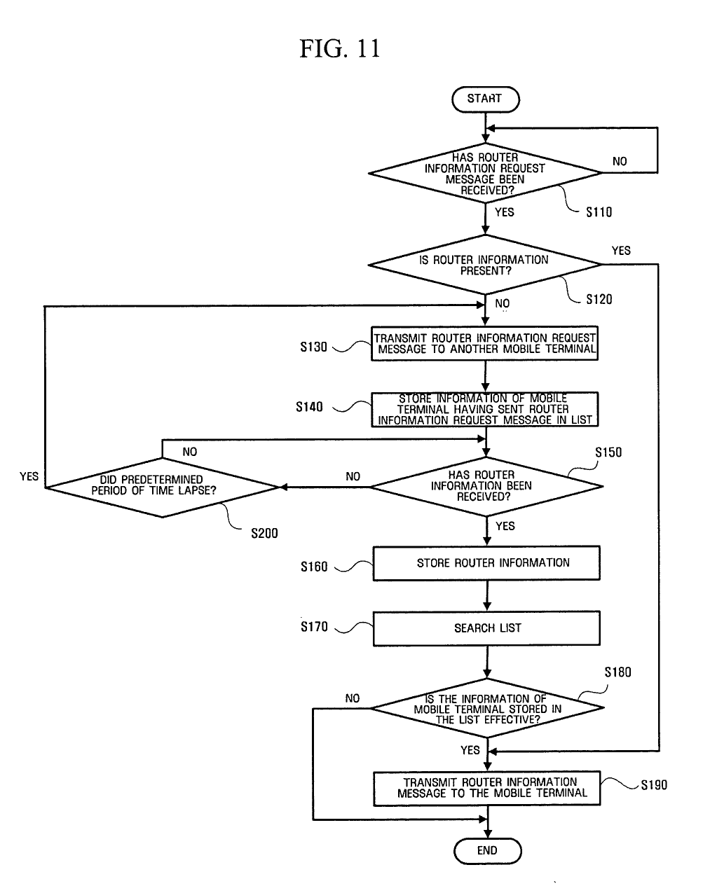

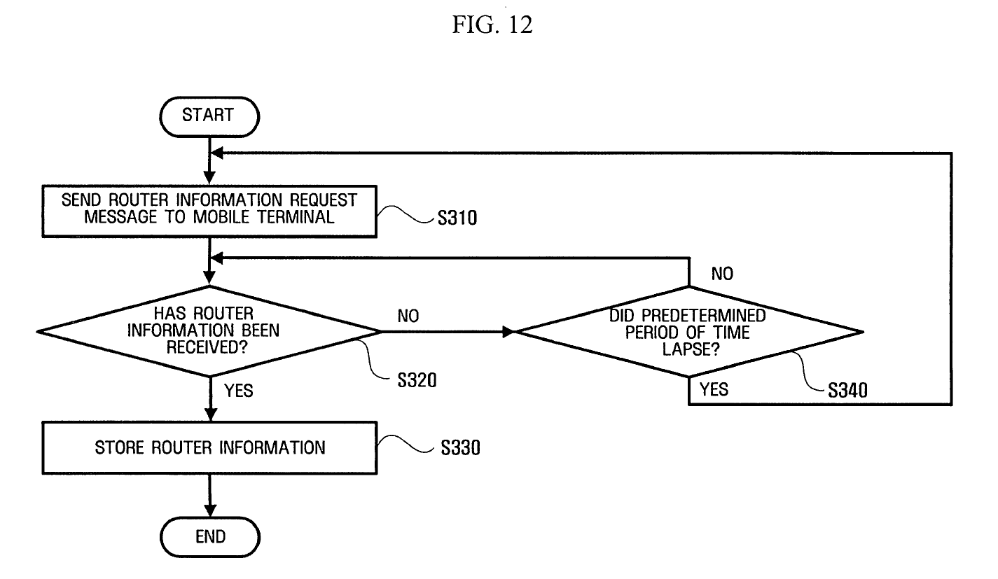

The method by which the first mobile terminal 100 sends router information to a mobile terminal having sent a router information request message is illustrated in FIG. 11.

In operation S110, the first mobile terminal 100 determines whether a router information request message has been received from a predetermined mobile terminal.

As described above, the router information request message may be received from a mobile terminal within 1-hop distance from the first mobile terminal 100 or from a mobile terminal apart more than 1-hop distance from the first mobile terminal 100.

If it is determined that the router information request message has been received, the first mobile terminal 100 determines whether it has router information regarding a current wireless network in operation S120.

If it is determined that the first mobile terminal 100 does not have the router information, the first mobile terminal 100 transmits the router information request message to another mobile terminal within 1-hop distance therefrom in operation S130.

Here, before the first mobile terminal 100 transmits the router information request message, a mobile terminal address contained in the received router information request message is converted to an address of the first mobile terminal 100.

In operation S140, the first mobile terminal 100 stores in a list of the list storage unit 120 information of the mobile terminal having sent the router information request message to the first mobile terminal 100.

The information of the mobile terminal stored in the list of the list storage unit 120 is as shown in FIG. 4.

Here, to avoid redundantly receiving the router information request message from the same mobile terminal, the first mobile terminal 100 may ignore the router information request message from a mobile terminal having the same address and ID as an address 310 and ID 320 stored in the list storage unit 120.

In operation S150, the first mobile terminal 100 determines whether a router information message has been received from the mobile terminal to which the first mobile terminal 100 was sent the router information message. If it is determined that the router information message has been received, the first mobile terminal 100 stores the received router information message in the first information storage unit 110 in operation S160.

Thereafter, the first mobile terminal 100 searches a list stored in the list storage unit 120 in operation S170 and determines whether the information of the mobile terminal contained in the list is effective in operation S180.

Here, a difference between the time when the information of the mobile terminal was stored in the list storage unit 120 and a current time is calculated, and if the difference therebetween exceeds a predetermined period of time, the information of the mobile terminal contained in the list is determined as ineffective.

If it is determined that the information of the mobile terminal contained in the list stored in the list storage unit 120 is effective, the first mobile terminal 100 transmits the router information message stored in the first information storage unit 110 to the mobile terminal in operation S190.

Here, before transmitting the router information message stored in the first information storage unit 110, it may be determined whether the path of an access router in accordance with router information contained in the router information message is effective.

Determination of the effectiveness of router information may be performed when the first mobile terminal 100 receives updated router information of the current wireless network. The effectiveness of the updated router information may be determined based on the path of an access router.

In detail, if the path of an access router is not found, the first mobile terminal 100 may determine that transmission is impossible and may not transmit the router information.

If it is determined that the first mobile terminal 100 does not receive the router information message within a predetermined period of time from the mobile terminal to which the first mobile terminal 100 sent the router information request message in operation S200, the first mobile terminal 100 retransmits the router information request message.

Meanwhile, the router information stored in the first mobile terminal 100 may have a predetermined effective duration.

The effective duration of the router information may be randomly and independently set in a range between a predetermined minimum value and a predetermined maximum value by individual mobile terminals.

If the effective durations of router information stored in all mobile terminals included in a wireless network are the same, all of the mobile terminals may request router information from the access router 400 at the same time. As a result, traffic in the wireless network increases.

FIG. 12 is a flowchart of a method by which the second mobile terminal 200 receives router information.

In operation S310, the second mobile terminal 200 sends a router information request message to a mobile terminal within I-hop distance.

If a router information message corresponding to the router information request message is received in operation S320, the second mobile terminal 200 stores the received router information message in the second information storage unit 230 in operation S330.

If the router information message is not received within a predetermined period of time, the second mobile terminal 200 retransmits the router information request message in operation S340.

The above-described information processing apparatus and method for a wireless network according to embodiments of the present invention can reduce the number of messages transmitted in the wireless network compared to the structure shown in FIG. 2.

When the number of mobile terminals in a wireless network including a plurality of access routers is “n” and the number of mobile terminals located at a border each access router is “i”, the number of message transmissions is “2n” in conventional technology. In the present invention, the total number of message transmissions is M expressed by Equation 1:
M=n+i (1)
where “i” is the number of mobile terminals receiving router information messages from all of the access routers among mobile terminals located at the border of each access router.

Since at least one mobile terminal among the mobile terminals located at the border of each access router can receive router information messages from all of the access routers, “i” may be less than or equal to the total number of access routers.

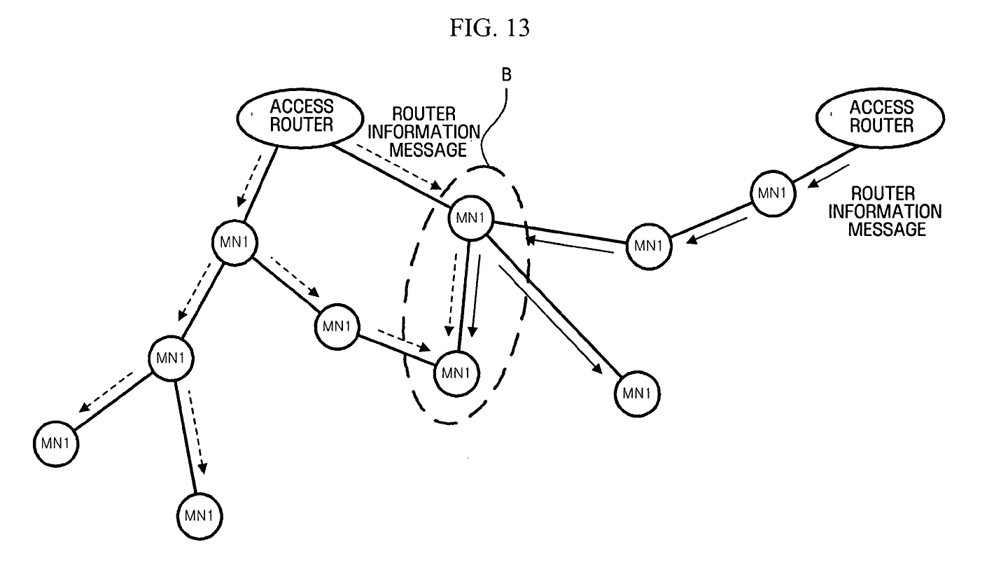

In other words, when a plurality of access routers exist and at least one mobile terminal is located at a border B of each access router, as shown in FIG. 13, the total number of message transmissions “M” can be expressed by Equation 1.

Table 1 shows comparison between the present invention and the conventional technology in terms of the number of transmission messages versus the number of access routers.

TABLE 1

| Number of access | Conventional | |
|---|---|---|
| routers | technology | Present invention |
| 1 | N | n |
| 2 | 2 n | n + i |
| 3 | 3 n | n + i |

In Table 1, “n” is the number of mobile terminals in a wireless network and “i” is the number of mobile terminals receiving router information messages from all of the access routers among mobile terminals located at the border of each access router.

A mobile terminal receiving a plurality of router information messages from different access routers at the border of each access router may select one among the plurality of router information messages according to predetermined conditions. For example, a mobile terminal located at the border of each access router can selectively receive a router information message transmitted from an access router within minimum hop distance therefrom. A condition for selectively receiving a router information message may vary with network policy.

The mobile terminal located at the border of each access router may identify a wireless network to which the mobile terminal belongs based on the received router information message and automatically configure an address.

In addition, after selectively receiving the router information message according to the predetermined condition, the mobile terminal may ignore other router information messages.

Meanwhile, in embodiments of the present invention, since the first mobile terminal 100 and the second mobile terminal 200 exist in the same wireless network, they can transmit and receive messages using the same protocol.

When the first mobile terminal 100 and the second mobile terminal 200 transmit and receive messages to and from a network using a protocol different from the protocol of the current wireless network via the access router 400, the access router 400 can convert the protocols between the networks using different protocols.

In an embodiment of the present invention, the first mobile terminal 100 and the second mobile terminal 200 use a MANET protocol and they transmit and receive messages to and from a network using an IPv6 protocol via the access router 400.

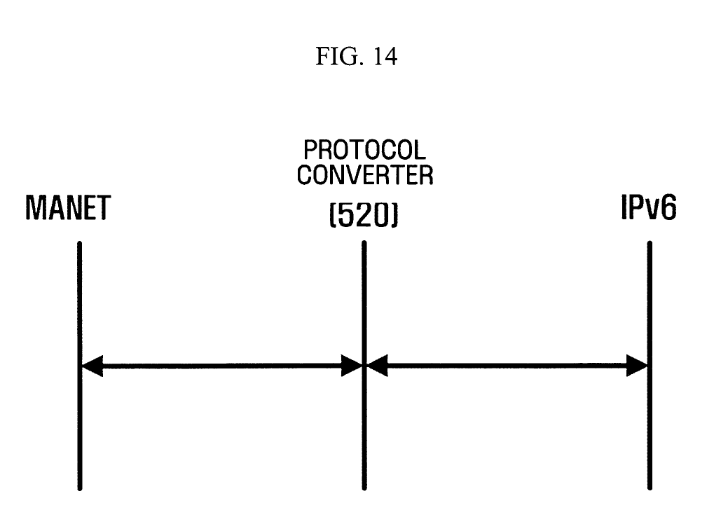

Accordingly, as shown in FIG. 14, the protocol converter 520 can appropriately convert protocols between the first message transceiver 510 using the MANET protocol and the second message transceiver 530 using the IPv6 protocol.

The present invention can be applied to the MANET and a Link State Routing Protocol (OLSR) and is not restricted thereto.

While an information processing apparatus and method for a wireless network have been described with regard to the accompanying drawings, the invention may not be limited thereto but may be modified in other implementations consistent with the principles of the invention.

As described above, according to the present invention, since a mobile terminal requesting router information regarding a wireless network does not broadcast a message over the wireless network, traffic in the wireless network is reduced. As a result, delay in normal communication and packet loss occurring in mobile terminals can be prevented.

1. An information processing apparatus for a wireless network, comprising:
a list storage unit storing a list containing information of a mobile terminal sending a router information request message regarding the wireless network;
a first information storage unit storing router information regarding the wireless network; and
an information transmitter transmitting the router information to the mobile terminal contained in the list.

2. The information processing apparatus of claim 1, wherein the list comprises an address of the mobile terminal sending the router information request message, an ID of the router information request message, and a time when the router information request message is received.

3. The information processing apparatus of claim 2, wherein the router information request message is received from a mobile terminal within 1-hop distance from the information processing apparatus.

4. The information processing apparatus of claim 3, wherein the router information is received from a mobile terminal within 1-hop distance from the information processing apparatus.

5. The information processing apparatus of claim 4, wherein the information transmitter transmits the router information to the mobile terminal having sent the router information request message after the router information is stored in the first information storage unit.

6. The information processing apparatus of claim 5, wherein a router corresponding to the router information converts a protocol of a message to be transmitted to a network using a protocol different from the protocol of the current wireless network.

7. An information processing apparatus for a wireless network, comprising:
an information requester sending a router information request message to a mobile terminal of the wireless network;
an information receiver receiving router information corresponding to the router information request message; and
a second information storage unit storing the received router information.

8. The information processing apparatus of claim 7, wherein the mobile terminal is within 1-hop distance from the information processing apparatus.

9. The information processing apparatus of claim 7, wherein the information requester retransmits the router information request message when the router information is not received within a predetermined period of time.

10. The information processing apparatus of claim 9, wherein the router converts a protocol of a message to be transmitted to a network using a different protocol.

11. An information processing method for a wireless network, comprising:
storing a list containing information of a mobile terminal sending a router information request message regarding the wireless network;
storing router information regarding the wireless network; and
transmitting the stored router information to the motile terminal contained in the list.

12. The information processing method of claim 11, wherein the router information request message is received from a mobile terminal within 1-hop distance from the information processing apparatus.

13. The information processing method of claim 12, wherein the list comprises an address of the mobile terminal sending the router information request message, an ID of the router information request message, and a time when the router information request message is received.

14. The information processing method of claim 13, wherein the storing of the router information comprises:
sending the router information request message to a mobile terminal within 1-hop distance from the information processing apparatus;
retransmitting the router information request message when the router information is not received within a predetermined period of time.

15. The information processing method of claim 14, wherein the router converts a protocol of a message to be transmitted to a network using a different protocol.

16. An information processing method for a wireless network, comprising:
sending a router information request message to a mobile terminal of the wireless network;
receiving router information corresponding to the router information request message; and
storing the received router information.

17. The information processing method of claim 16, wherein the router information request message is transmitted to a mobile terminal within 1-hop distance from the information processing apparatus.

18. The information processing method of claim 17, further comprising retransmitting the router information request message when the router information is not received within a predetermined period of time.

19. The information processing method of claim 18, wherein the router converts a protocol of a message to be transmitted to a network using a different protocol.
